(19) United States
(12) Patent Application Publication
(10) Pub. No.: US 2017/0122659 A1
(43) Pub. Date: May 4, 2017

(54) PROCESS AND APPARATUS FOR SWEETENING AND LIQUEFYING A GAS STREAM

(71) Applicant: SHELL OIL COMPANY, Houston, TX (US)

(72) Inventors: Nimalan GNANENDRAN, Thornlie (AU); Martin WILKES, Perth (AU)

(21) Appl. No.: 15/351,148

(22) Filed: Nov. 14, 2016

Related U.S. Application Data
(62) Division of application No. 13/375,639, filed on Apr. 12, 2012, now abandoned.

(30) Foreign Application Priority Data
Jun. 12, 2009 (AU) 2009902752

(51) Int. Cl. F25J 1/00; C10L 3/10; B01D 53/00; B01D 53/14; F25J 1/02; F25J 3/02

(52) U.S. Cl. CPC F25J 1/0022; F25J 1/0082; F25J 1/0087; F25J 1/0288; F25J 3/0209; F25J 3/0266; F25J 3/0233; F25J 3/0247; B01D 53/002; B01D 53/1475; C10L 3/102; C10L 3/104; F25J 2205/50; F25J 2220/60; F25J 2220/62; F25J 2220/66; F25J 2270/12; B01D 2252/2021; B01D 2252/30; B01D 2252/205; B01D 2252/202

(57) ABSTRACT

A process and apparatus for liquefying a gas stream comprising hydrocarbons and sour species is provided in which the sour species are removed in liquefied form as the sweetened gas stream is progressively cooled to liquefaction temperatures. The process involves cooling the gas stream in a manner to produce a cooled gas stream comprising gaseous hydrocarbons and residual sour species. The cooled gas stream is then treated with a cold solvent to deplete the cooled gas stream of residual sour species. The resulting cooled sweetened gas stream is then further cooled to produce liquid hydrocarbons.

### CROSS-REFERENCE TO RELATED APPLICATIONS

The present application is a divisional application claiming benefit of U.S. application Ser. No. 13/375,639, filed Apr. 12, 2012, which is a National Stage (§371) application of PCT/AU2010/000722, filed Jun. 11, 2010, which claims priority from Australian Application No. 2009902752, filed Jun. 12, 2009, which is incorporated herein by reference in its entirety.

### FIELD

The present invention relates to a process and apparatus for sweetening and liquefying a gas stream. In particular, the present invention relates to a process and apparatus for removing sour species in a liquefied form from the gas stream as the sweetened gas stream is progressively cooled to liquefaction temperatures.

### BACKGROUND

Global energy demand is projected to increase by almost 3% annually over the next twenty-five years. The increasing demand for the usage of light hydrocarbon gas, such as methane, as a primary energy source is driving the development of natural gas fields that had previously been considered sub-economic, including those containing significant concentrations of carbon dioxide. Additionally, hydrocarbon gas is increasingly being sourced from coal bed and coal seam mining operations, associated gas stream sources, and anthropogenic sources such as landfill gas and biogas.

Although hydrocarbon gas combustion produces significantly lower carbon dioxide emissions than oil or coal, for sources containing high concentrations of carbon dioxide the advantage is lessened or even negated if the carbon dioxide removed in pre-combustion gas processing plants is vented to the atmosphere instead of being captured and stored, for example in sub-surface geological formation.

Additionally, the presence of water and other compounds such as hydrogen sulphide, mercaptans, and mercury which are also referred to as “sour” species or contaminants found in hydrocarbon gas, regardless of the sources listed above, is also problematic. Water and sour contaminants promote corrosion and form solids under conditions commonly found in process operations and distribution networks.

The formation of solids in pipe work or equipment is generally undesirable, as the accumulation of such solids eventually results in decreased operating performance and can quickly lead to total blockage, breakdown or other damage. For safety and operational reasons it is necessary to reduce concentrations of water and sour contaminants down to acceptable levels.

Additionally, it is necessary to comply with legal or commercial requirements concerning maximum allowable concentrations of sour contaminants within a hydrocarbon gas product stream.

Accordingly, in the processes currently employed to liquefy hydrocarbon gas, a feed gas is initially pre-treated to deplete carbon dioxide to about 50-200 ppm and remove other sour species. The pre-treatment process is typically a chemical solvent process (amine), but may also be a physical solvent or a hybrid membrane/solvent process.

The pre-treated gas is then dehydrated, typically with molecular sieves, before feeding it to a liquefaction plant where the dehydrated sweetened gas is cooled to temperatures at which light hydrocarbons, in particular methane, condense, typically to temperatures of about −160° C. For feed gases with relatively high carbon dioxide content, the capital and energy expenditure to remove carbon dioxide to about 50-200 ppm by means of the aforementioned conventional techniques is expensive and requires significant utility infrastructure, thereby increasing the environmental footprint of the liquefaction plant.

U.S. Pat. No. 5,956,971 describes a process for producing pressurized liquefied natural gas (PLNG) in which the natural gas feed stream comprises sour species such as CO₂, H₂S or any other compound that has the potential to form solids at cryogenic temperatures required to condense methane. In this process, a separation system containing a controlled freezing zone (“CF2”) produces a vapour stream rich in methane and a liquid stream rich in the freezable component. The vapour stream is then cooled to a temperature above about −112° C. at a pressure sufficient to produce a pressurised liquefied natural gas stream. Under the warmer operating temperature of this process it is possible to provide PLNG with CO₂ levels as high as about 1.4 mol % CO₂ at temperatures of −112° C. and about 4.2% at −95° C. without causing freezing problems in the liquefaction process.

There is a continuing need for an improved process for liquefying natural gas that contains sour species in concentrations that would freeze during the liquefaction process which can be integrated with conventional operating conditions of existing natural gas liquefaction plants, and which reduces the concentration of sour species such as CO₂ to less than 50 ppm.

The present invention seeks to overcome at least some of the aforementioned disadvantages.

### SUMMARY

In its broadest aspect, the invention provides a process and apparatus for liquefying a gas stream contaminated by sour species in which the sour species are removed from the gas stream in a liquefied form as the gas stream is progressively cooled to liquefaction temperatures.

Accordingly, in a first aspect of the present invention there is provided a process for liquefying a gas stream comprising hydrocarbons and sour species, the process comprising the steps of:
a) cooling the gas stream in a manner to produce a cooled gas stream comprising gaseous hydrocarbons and residual sour species;
b) treating the cooled gas stream with a solvent to deplete the cooled gas stream of residual sour species, thereby producing a cooled sweetened gas stream; and
c) cooling the cooled sweetened gas stream to produce liquid hydrocarbons.

The term “residual sour species” as used herein refers to a residual concentration of sour species remaining in a vapour phase, whereby further cooling under process operating conditions is unable to appreciably convert the sour species to a solid and/or liquid phase. For example, where the sour species is carbon dioxide, a residual concentration of carbon dioxide may be about 2-4%.

It will be appreciated that the gas stream should be dehydrated sufficiently to reduce water content to very low concentrations suitable for LNG production, in particular to a concentration of 1 ppmv or less, and preferably less than 0.1 ppmv. An example of a suitable dehydration process includes the adsorption of water from the gas stream with dessicants, such as for example, molecular sieves or silica gel. Alternatively, dehydration by adsorption using glycol or methanol may be possible, or other suitable dehydration processes known in the art.

In one embodiment of the invention, in step a), cooling is conducted in a manner whereby the gas stream is cooled to a first temperature to produce a mixture of solid and/or liquid sour species and a vapour containing gaseous hydrocarbons and residual sour species. The solid and/or liquid sour species are separated from the mixture, thereby producing the cooled gas stream.

In one form of the invention, in step a) cooling is conducted under a first set of temperature and pressure conditions at which the sour species solidifies and/or a condensate containing sour species forms. It will be appreciated that said first set of temperature and pressure conditions will vary in accordance with the composition of the gas stream. In one embodiment of the invention, the first temperature is at or just below the temperature at which the sour species solidifies and/or condenses.

In an alternative embodiment of the invention, in particular where the concentration of sour species in the gas stream can be regarded as already substantially residual, such as for instance, pipeline gas, the gas stream is cooled in step a) to a first temperature at which freezable hydrocarbon species may condense. In one form of the invention, the condensed hydrocarbon species are separated from the mixture, thereby producing the cooled gas stream.

Additionally and/or alternatively, the gas stream may be cooled in step a) to a first temperature at which solubility of the residual sour species in the solvent used in step b) is optimized.

In one embodiment of the invention, in step b) treating the cooled gas stream with a solvent comprises contacting the cooled gas stream with a solvent in which the sour species is more soluble than the gaseous hydrocarbons.

In one embodiment of the invention, step b) is performed under temperature conditions close to or at the first temperature. Advantageously, the inventors have found that treating the cooled gas stream with solvent at temperatures close to or at the first temperature increases the absorption of sour species in the solvent thereby resulting in very low concentrations of sour species, such as for example <50 ppm CO₂, in the cooled sweetened gas stream.

Thus, although the first temperature in step a) is primarily determined by the temperature at which sour species condense, in instances where the concentration of sour species in the gas stream can be regarded as already substantially residual, it will be appreciated that the first temperature to which the gas stream is cooled is also determined by a balance of considerations between solubility of sour species in the solvent used in step b), degree of co-absorption of hydrocarbons in the solvent used in step b), and the overall refrigeration requirements of the process.

In one embodiment, in step c), cooling is conducted under a second set of temperature and pressure conditions at which hydrocarbons in the cooled gas stream, in particular methane, condense. It will be appreciated that said second set of temperature and pressure conditions will vary in accordance with the composition of the remaining gaseous hydrocarbons in the cooled gas stream.

In one form of the invention, in step a) and/or step c) cooling the gas stream comprises expanding the gas stream in one or more expansion steps. In an alternative form of the invention, in step a) and/or step c) cooling the gas stream comprises effecting an indirect heat exchange with one or more cooling streams. Suitable cooling streams may be a process stream at a lower temperature than the gas stream or an external refrigerant stream. In another alternative form in step a) and/or step c) cooling the gas stream comprises effecting a direct heat exchange with a cooling stream. In a preferred form of the invention, in step a) and/or step c) cooling the gas stream comprises one or more heat exchange and/or expansion steps.

In another embodiment of the invention, the solid and/or liquid sour species are separated from the mixture under gravity, centrifugal force, or with other suitable separation means.

In some embodiments the process further comprises the step of removing the solid sour species, preferably by heating and melting the solid sour species, thereby forming a liquid rich in sour species. Such an arrangement is described in WO 2007/030888. The resultant liquid sour species may be subsequently removed and diverted to other parts of the plant. For example, a cool liquid carbon dioxide stream may be used as one of the process streams to cool the gas stream in step a) by indirect heat exchange.

In one embodiment, the process comprises heating the solid sour species to a temperature at or just above the melting point of the solid sour species.

In a further embodiment of the invention, prior to performing step a) the process further comprises the step of cooling the gas stream in a manner arranged to produce a liquid stream of carbon dioxide, ethane and C3+ hydrocarbons and a gas stream having a reduced carbon dioxide concentration. In a still further embodiment of the invention, prior to performing step a) the process further comprises the step of cooling the gas stream under a set of temperature and pressure conditions arranged to produce a C3+ hydrocarbon liquid and a C3+ hydrocarbon-depleted gas stream, and separating the C3+ hydrocarbon liquid and the C3+ hydrocarbon-depleted gas stream, for example as described in WO2008/095258. The gas stream having a reduced carbon dioxide concentration or the C3+ hydrocarbon-depleted gas stream is then cooled to a first temperature to produce a mixture of solid and/or liquid sour species and a vapour containing gaseous hydrocarbons and residual sour species as described above.

In a second aspect of the present invention there is provided a gas liquefaction apparatus for liquefying a gas stream comprising hydrocarbons and sour species, the gas liquefaction apparatus being provided with:

a first cooling zone for cooling the gas stream in a manner to produce a cooled gas stream comprising gaseous hydrocarbons and residual sour species, the first cooling zone being in fluid communication with a source of gas comprising hydrocarbons and sour species; a separator to separate solids and/or liquids from the cooled gas stream;
a vessel arranged, in use, to treat the cooled gas stream with a solvent to deplete the cooled gas stream of residual sour species, thereby producing a cooled sweetened gas stream; and a second cooling zone in fluid communication with the vessel, the second cooling zone being configured to receive and cool the cooled sweetened gas stream to a second temperature to produce liquid hydrocarbons.

In one embodiment, the first cooling zone and the second cooling zone, respectively comprise one or more means for cooling the gas stream. In one form of the invention said cooling means is a gas expander. Suitable examples of gas expanders include but are not limited to a Joule-Thomson valve, an orifice or venturi, a turbo expander, or a turbo expander in sequential combination with a Joule-Thomson valve. It will be appreciated that the gas expander can define an inlet of a vessel for cooling the gas stream or an inlet of the separator. Similarly, it will be understood that the separator may additionally function as a cooling vessel in which the gas stream is cooled to a first temperature.

In another form of the invention said cooling means is a heat exchanger configured to facilitate indirect heat exchange with one or more cooling streams. Suitable examples of said heat exchangers include but are not limited to plate and fin type heat exchanger, tube-in-shell type heat exchanger, cooling coil, or coiled bundle. It will be appreciated that the cooling streams may be a process stream produced upstream or downstream of the heat exchanger, or an external refrigerant stream in fluid communication with an external refrigeration system. Exemplary examples of external refrigeration systems include cascading refrigeration systems, single mixed refrigerant systems, double mixed refrigerant systems, ammonia absorption chillers, and so forth.

In another form of the invention said cooling means is configured to facilitate direct heat exchange with a cooling stream.

In a preferred form of the invention, the first and second cooling zones respectively comprise one or more heat exchangers and/or gas expanders.

In one embodiment of the invention, the vessel arranged to treat the cooled gas stream with a solvent is an absorber column.

In a subsequent embodiment of the invention the apparatus still further comprises a means for heating the solid sour species to a temperature at or just above the melting point of the solid sour species. In one form of the invention, said heating means is a heater, in particular an immersion heater.

Depending on gas composition, the first cooling zone may additionally comprise a fractionating column arranged in use to operate under a third set of temperature and pressure conditions to produce a liquid stream of carbon dioxide, ethane and C3+ hydrocarbons and a gas stream having a reduced carbon dioxide concentration. In another form of the invention, the fractionating column may be operated under a further set of temperature and pressure conditions arranged to produce a C3+ hydrocarbon liquid and a C3+ hydrocarbon-depleted gas stream. The fractionating column is therefore arranged to perform bulk removal of carbon dioxide and/or recover valuable C3+ hydrocarbon liquids (i.e. NGLs).

In a further form of the invention the liquid produced from the fractionating column may be fed to further fractionating columns operated under temperature and pressure conditions to produce LPG components, heavier C5+ hydrocarbon liquids and/or a carbon dioxide rich stream, as described in WO 2009/095258.

In prior art systems, carbon dioxide is typically removed from the gas stream prior to liquefaction by passing it through an amine absorption unit, and then stripping the carbon dioxide from the amine absorption unit and venting to atmosphere. Alternatively, the gaseous carbon dioxide can be liquefied with costly compression processes. A substantial number of potential gas fields are not regarded as economically viable as the carbon dioxide content of the natural gas feed stream at the well head is regarded as too high to be processed, and disposed of, economically.

The present invention is based on the realisation that it is possible to recover liquid carbon dioxide from a gas stream comprising hydrocarbons and sour species during a gas liquefaction process. The liquid carbon dioxide can then be pumped and sequestered with relatively little additional energy requirements, as opposed to releasing carbon dioxide emissions.

Thus, in a third aspect of the present invention there is provided a process for recovering liquid carbon dioxide from a gas stream comprising hydrocarbons and carbon dioxide during hydrocarbon liquefaction, the process comprising the steps of:

a) cooling the gas stream to a first temperature to produce a mixture of solid and/or liquid carbon dioxide and a vapour containing gaseous hydrocarbons;
b) separating the solid and/or liquid carbon dioxide from the mixture, thereby producing a cooled gas stream comprising gaseous hydrocarbons and residual carbon dioxide;
c) heating the separated solid carbon dioxide and producing liquid carbon dioxide;
d) treating the cooled gas stream with a solvent to deplete the cooled gas stream of residual carbon dioxide, thereby producing a cooled sweetened gas stream; and
e) cooling the cooled gas stream to a second temperature to produce liquefied hydrocarbons.

The recovery of liquid carbon dioxide in a form suitable to store and/or sequester by the process defined above facilitates a relative reduction in greenhouse gas emissions in comparison to prior art liquefaction processes in which the carbon dioxide content of the gas stream would be vented to the atmosphere.

According to a fourth aspect of the invention there is provided a method of creating a financial instrument tradable under a greenhouse gas Emissions Trading Scheme (ETS), the method comprising the step of exploiting a process for liquefying a gas stream defined by the first aspect of the invention.

In a fifth aspect of the invention there provided a method of creating a financial instrument tradable under a greenhouse gas Emissions Trading Scheme (ETS), the method comprising the step of exploiting a gas liquefaction plant defined by the second aspect of the invention.

In a sixth aspect of the invention there is provided a method of creating a financial instrument tradable under a greenhouse gas Emissions Trading Scheme (ETS), the method comprising the step of exploiting a process for recovering carbon dioxide from a gas stream comprising hydrocarbons and carbon dioxide during liquefaction defined by the third aspect of the invention.

In one embodiment of the invention, the financial instrument comprises one of either a carbon credit, carbon offset or renewable energy certificate.

### BRIEF DESCRIPTION OF THE FIGURES

Preferred embodiments of the present invention will now be described, by way of example only, with reference to the accompanying figures, in which:

FIG. 1 shows a process flow diagram in accordance with one embodiment of the present invention whereby a cascade refrigeration system for liquefying natural gas is integrated with removal of sour species from a gas stream; and

FIG. 2 shows a process flow diagram in accordance with another embodiment of the present invention whereby a dual-mixed refrigerant system for liquefying natural gas is integrated with removal of sour species from a gas stream.

### DESCRIPTION OF A PREFERRED EMBODIMENT

In the description of the Figures reference is made to a natural gas stream as an example of the gas stream that may be treated in the process according to the present invention. It will be appreciated, however, that the gas stream may be any stream of gas that comprises hydrocarbons and sour species. Illustrative examples of such gas streams include, but are not limited to, natural gas, coal seam gas, associated gas, landfill gas, and biogas. The composition of the gas stream may vary significantly but the gas stream will generally contain methane, ethane, higher hydrocarbons (C3+), water, and sour species. The term “sour species” means any one or more of carbon dioxide, hydrogen sulphide, carbon disulfide, carbonyl sulphide, mercaptans (R—SH, where R is an alkyl group having one to 20 carbon atoms), sulphur dioxide, aromatic sulphur-containing compounds, and aromatic hydrocarbons such as benzene, toluene, xylene, naphthalenes, and so forth.

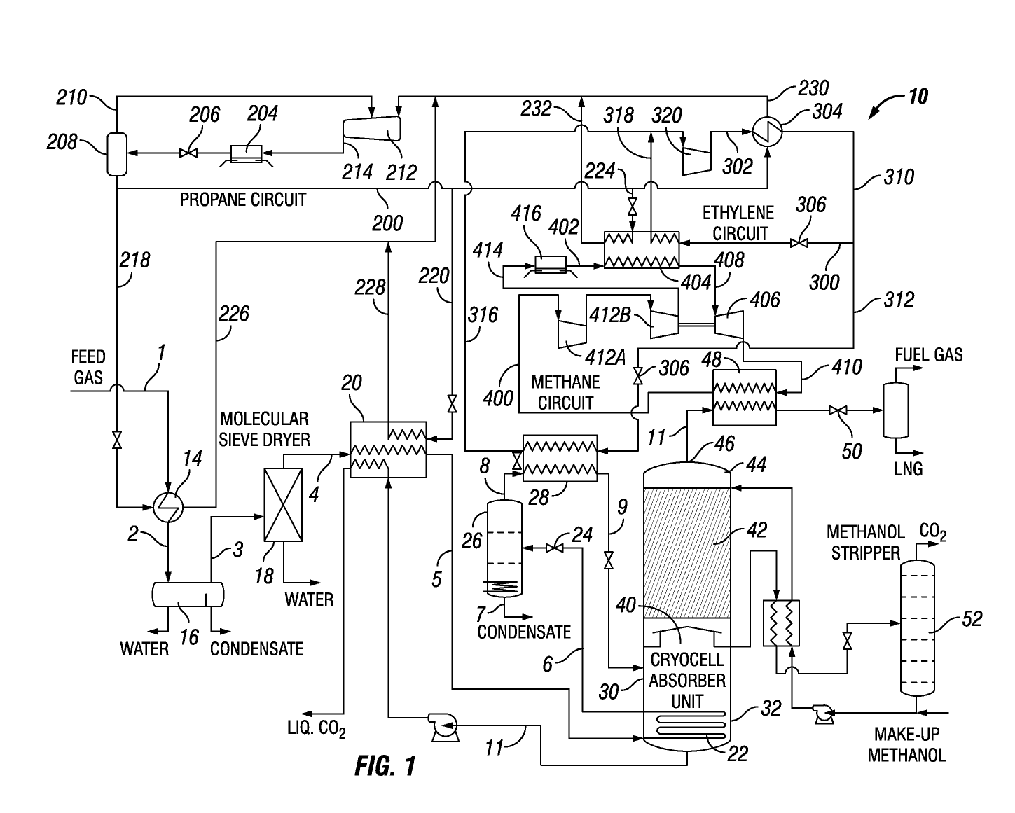

Referring to FIG. 1, in accordance with various aspects of the present invention, there is shown a gas liquefaction apparatus 10 for performing the process of the present invention, whereby a cascaded refrigeration system is utilized for cooling. In this particular embodiment, the cascaded refrigeration system comprises a first refrigeration circuit 200, a second refrigeration circuit 300 and a third refrigeration circuit 400. The preferred refrigerant in the first refrigeration circuit 200 is propane. The preferred refrigerant in the second refrigeration circuit 300 is ethylene or ethane, most preferably ethylene. The preferred refrigerant for the third refrigeration circuit 400 is methane, but may contain small concentrations of nitrogen and other light hydrocarbons.

A feed gas stream is introduced to the apparatus 10 via a line 1 to a heat exchanger 14 where the gas stream is cooled to a temperature just above the temperature at which hydrocarbon hydrates form (typically around 20° C.). Water will condense, and, depending on the composition of the feed gas stream, heavy hydrocarbon condensates may also form in heat exchanger 14. Cooling is effected in the heat exchanger 14 by indirect heat exchange with a propane refrigerant from the first refrigeration circuit 200. The gas stream is passed via a line 2 to a separator 16 to remove any condensed liquid hydrocarbons, for example C5+, and water which may have formed, and subsequently forwarded via a line 3 to a dehydrating unit 18 where it is dehydrated.

The gas stream may be dehydrated by any suitable dehydration process that will reduce the water content to very low concentrations suitable for LNG production, in particular to a concentration of 1 ppmv or less, and preferably less than 0.1 ppmv. A suitable dehydration process includes the adsorption of water from the gas stream with molecular sieves or silica gel.

Following dehydration, the gas stream is passed from the dehydrating unit 18 via line 4 to a heat exchanger 20 where the gas stream is further cooled. Cooling is effected by indirect heat exchange with a cooled stream of liquid sour species and propane refrigerant from the first refrigeration circuit 200.

The gas stream is then passed via line 5 to a heat exchange tube bundle 22 in indirect heat exchange with a slurry of sour species solids in liquid sour species where it is further cooled. The gas stream is passed via line 6 to valve 24 where it is flashed to a pressure below the critical pressure of the gas, and passed to a fractionation column 26 in which a condensate mainly comprising C3 and C4 hydrocarbons and heavier hydrocarbons is separated from the gas stream. The resultant condensate stream may also contain carbon dioxide and ethane. The condensate is then directed through a line 7 to a condensate stabilizer or other fractionators (not shown) for further treatment to recover other saleable higher hydrocarbon product(s).

The operating conditions of the fractionation column 26 are determined according to the composition of the gas stream, in particular the content of sour species therein. For example, in a gas stream containing less than about 15% carbon dioxide, the operating conditions of the fractionation column 20 are selected to ensure condensation of substantially all hydrocarbon compounds that could solidify under temperatures and pressures at which methane condenses, so that said hydrocarbon compounds are removed from the gas stream. Generally, the temperature conditions under these requirements are around −15° C. at the inlet to the fractionation column 26 and about −30° C.-−40° C. at the outlet of a reflux condenser at a top of the fractionation column 26, at operating pressures of around 55-60 barg.

Alternatively, in a gas stream containing greater than about 15% carbon dioxide, the operating conditions of the fractionation column 26 are selected, primarily, to deplete the gas stream of carbon dioxide to concentrations less than 15%. Additionally, the operating conditions are selected to ensure that there is minimal methane condensation. Generally, the temperature conditions under these requirements are about −35° C.-−45° C. at the inlet to the fractionation column 20 and about −55° C.-−60° C. at the outlet of a reflux condenser at a top of the fractionation column 26, at operating pressures of around 55-60 barg. It will be appreciated that under these operating conditions there is also concomitant condensation of substantially all hydrocarbon compounds that could solidify under typical methane liquefaction temperatures.

The gas stream from the top of the fractionation column 26 is directed through a line 8 to heat exchanger 28 to cool the gas stream to a temperature marginally greater than a temperature at which solidification of the sour species in the gas stream occurs. Generally, the gas stream is cooled to a temperature in a range of about −65° C. to −70° C. Cooling in heat exchanger 28 may be obtained from indirect heat exchange with process streams derived downstream of the apparatus 10, such as for instance, liquefied hydrocarbon or refrigerant streams from an external refrigeration system. In this particular embodiment, the cooling stream is ethylene refrigerant from the second refrigeration circuit 300.

The gas stream is then fed via line 9 to an inlet 30 of separation vessel 32. The gas stream is expanded using a Joule-Thomson valve or other suitable expansion means such as a turbo expander to further cool the stream as it enters the vessel 32. In one embodiment, the gas stream is expanded using a turbo expander in sequential combination with the Joule-Thomson valve. In another form of the invention, the Joule-Thomson valve can define the inlet 30 of the vessel 32.

The process of expanding the gas stream upon introduction to the vessel 32 is arranged to afford temperature and pressure conditions within the vessel 32 at which the sour species contained in the gas stream solidify and/or liquefy. The process of expansion typically cools the gas stream entering the vessel 32 at inlet 30 to about −80 to −95° C. at a typical pressure range of 15 to 25 bar.

Upon cooling the gas stream, as described above, a small amount of liquid condensate of NGL may also form under the temperature and pressure conditions in the cooling vessel 32.

The solid sour species and the liquid condensate migrate to a lower portion of the vessel 32 under gravity separation, thereby forming a slurry of natural gas liquids and solid and/or liquid sour species. In other embodiments, separation may be achieved or enhanced by the use centrifugal force or inlet devices designed to coalesce droplets or agglomerate solid particles.

The slurry of solid sour species is then heated to a temperature at least marginally greater than the solidification temperature of the solid sour species to convert the solid sour species to a liquid phase in the lower portion of the vessel 32 and afford a liquid stream rich in the sour species. The nature and concentration of the sour species in the liquid phase is highly dependant on the composition of the gas stream. For example, typically concentrations of carbon dioxide in the liquid phase are >70%. Typically, the vessel 32 is provided with an immersion heater which heats the slurry up to a temperature marginally greater than the melting point temperature of the solid sour species. In this particular embodiment, the immersion heater comprises the heat exchanger tube bundle 22 which cools the gas stream while heating the slurry. In small applications, the immersion heater may comprise an electric immersion heater.

The liquid stream rich in the sour species is removed from the vessel 32 through conduit 11. Under processing conditions where the liquid stream is rich in liquid carbon dioxide, the liquid stream may be directly pumped to a liquid carbon dioxide sequestration site, or disposed of for retail sale. Prior to sequestration or storage, the liquid stream rich in sour species may be used as a cooling stream in any one or more of the heat exchangers of the apparatus 10 to conserve energy within the apparatus 10. In this particular embodiment, the liquid stream rich in sour species is used as a cooling stream in heat exchanger 20.

The gas stream leaving vessel 32 contains residual sour species and is directed to a solvation zone 38. The solvation zone 38 may be disposed in an upper portion of the cooling vessel 32, as shown in FIG. 1. The cooled partially sweetened gas stream may be directed to the solvation zone 38 of the vessel 32 through a chimney tray 40 or a non-return valve.

In an alternative embodiment (not shown), the solvation zone 38 is located externally of the vessel 38 and a line is arranged in fluid communication between the vessel 32 and the solvation zone 38 to direct the cooled partially sweetened gas stream therebetween. In the alternative embodiment, the solvation zone 38 may comprise an absorber column.

The solvation zone 38, whether it is located internally or externally of the separating vessel 32, is configured to operate under temperature conditions close to or at the temperature to which the gas stream is cooled in separating vessel 32. As will be appreciated, the absorption of sour species, in particular carbon dioxide, in the solvent typically increases with a decrease in operating temperature. This factor is thus a driver for minimizing the operating temperature of the solvation zone as it leads to a reduced solvent circulation and regeneration requirements. Accordingly, where an absorber column is employed as the solvation zone 38, the absorber column is connected directly to the separating vessel 32 and operated at a temperature at or close to the first temperature in the separating vessel 32.

The operating temperature of the solvation zone 38 is also selected on a consideration of a counter balance with the co-absorption of methane in the solvent and overall refrigeration requirements, both of which increase with reducing temperature. Accordingly, the operating temperature of the solvation zone 38 is selected to ensure that sufficient sour species, in particular carbon dioxide, is absorbed in order to meet the required specification for liquefaction of methane (e.g. <50 ppm CO₂) whilst minimizing the co-absorption of methane, solvent circulation, and refrigeration and power requirements.

The solvation zone 38 is configured to optimize the contact area between the cooled liquid solvent and the cooled partially sweetened gas stream. In one embodiment of the invention, the solvation zone 38 is provided with liquid-gas intermixing means 42. Suitable examples of liquid-gas intermixing means 42 include, but are not limited to, a plurality of trays or structured packing disposed in the solvation zone 38 of the vessel 32.

The cooled liquid solvent is introduced into the solvation zone 38 of the vessel 32 through inlet 44 disposed above the liquid-gas intermixing means 42. In this particular embodiment, the inlet 44 is a distributor designed to deliver liquid solvent evenly to the liquid-gas intermixing means 42, such as a parting box and trough arrangements, drip tubes and/or lateral pipe distributors.

The cooled liquid solvent is selected to mix with and solvate the gaseous sour species in the partially sweetened gas stream and form a liquid solution of the gaseous sour species. Suitable examples of cooled liquid solvents in accordance with the present invention include but are not limited to NGL condensate comprising a mixture of C2, liquefied petroleum gas components, C3 and C4 and C5+ hydrocarbon components, or one or more other solvents including methanol, ethanol, dimethyl sulfoxide, ionic liquids including imidazolium, quaternary ammonium, pyrrolidinium, pyridinium, or tetra alkylphosphonium. For example, the cooled gas stream may be treated with methanol cooled to about −90° C. to absorb any residual sour species.

In this way, the cooled partially sweetened gas stream is sweetened to concentrations of 50-200 ppm CO₂, thereby making the cooled sweetened gas stream suitable to undergo further cooling to condense the light hydrocarbons, in particular methane. The cooled sweetened gas stream is removed from the solvation zone 38 at outlet 46 via line 11, and directed to a second cooling zone 48 comprising one or more heat exchangers where the cooled sweetened gas stream is cooled to a temperature at or below the temperature at which the hydrocarbons in the gas stream condense. Preferably, the cooled sweetened gas stream is cooled to a temperature below the methane boiling point, for example to a temperature between about −140° C. to −150° C. In this particular embodiment the second solvation zone 48 comprises a heat exchanger where cooling is provided by a methane refrigerant stream from the third refrigeration circuit 400.

The liquefied stream may be further expanded in expander 50 and cooled to about −162° C. and atmospheric pressure for storage purposes. In an alternative embodiment, the liquefied stream may be stored under slightly elevated pressure (e.g. about 5 Bara) and temperatures for storage as pressurized LNG (or PLNG).

It will be appreciated that if the process of the present invention is modified to produce pressurized liquid hydrocarbons, such as PLNG, the acceptable content of impurities in the gas stream (and indeed the CO₂ content) may be higher as pressurized LNG can hold more sour species, in particular CO₂, without freezing of these compounds occurring at temperatures and pressures where methane liquefaction takes place.

Rich solvent, in other words, spent solvent laden with absorbed sour species, is recovered from the solvation zone 38 and regenerated in a stripper column 52 to produce lean solvent along with make-up solvent. The lean solvent combined with make-up solvent is cooled in heat exchanger 54 and pumped to the inlet 44 of the liquid-gas intermixing means 42. The vapour sour species produced in the stripper column can be compressed and cooled to produce a sour liquid to be combined with sour liquid produced in column 32 to be then disposed (not shown).

Referring to FIG. 1, the configuration and operation of the first refrigeration circuit 200, having the highest boiling point among the three refrigeration circuits 200, 300, 400 employed in the present invention, such as propane, is described.

Propane refrigerant vapour stream 202 is cooled and condensed in an air-cooled condenser 204 and is directed via stream 202 to a pressure reduction device 206, for example a Joule-Thomson valve, and expanded to a lower pressure, thereby flashing a portion of the propane refrigerant stream and lowering its temperature. The resulting two-phase stream is separated in separator 208.

The top vapour product is passed via line 210 to an inlet of a propane compressor 212. Propane vapour is compressed in the propane compressor 212 and returned via line 214 to the propane condenser 204.

The bottom liquid product 216 is split and each resultant stream is expanded to a lower pressure in a pressure expansion device, further lowering its temperature and then used as respective cooling streams in indirect heat exchange with the following:
a) feed gas in heat exchanger 14 via conduit 218;
b) dehydrated feed gas in heat exchanger 20 via conduit 220;
c) second refrigerant stream, eg. ethylene in heat exchanger 304 via conduit 222; and
d) third refrigerant stream, eg. methane in heat exchanger 404 via conduit 224.

The respective refrigerant streams from conduits 226, 228, 230, and 232 are combined and directed to the inlet of propane compressor 212, where the combined stream is compressed in the propane compressor 212 and returned via line 214 to the propane condenser 204.

The configuration and operation of the second refrigeration circuit 300, eg. ethylene, is now described. As illustrated in FIG. 1, the ethylene refrigerant stream 302 is condensed in heat exchanger 304. It is then split and each stream directed to a pressure reduction device 306 and expanded to a lower pressure, thereby flashing a portion of the ethylene refrigerant stream and lowering its temperature, making it suitable for use as respective cooling streams in indirect heat exchange with the following:
a) cooled dehydrated gas stream in heat exchanger 28 via conduit 312; and
b) third refrigerant stream, eg. methane in heat exchanger 404 via conduit 314.

The respective ethylene refrigerant streams from conduits 316 and 318 are combined and directed to the inlet of an ethylene compressor 320, where the combined stream is compressed and returned via line 302 to the heat exchanger 304.

The configuration and operation of the third refrigeration circuit 400, eg. methane, is now described. As illustrated in FIG. 1, the methane refrigerant stream chilled in heat exchanger 404 is directed to a turbo expander 406 via line 408 and expanded to a lower pressure, thereby lowering its temperature.

The resulting methane refrigerant stream 410 is used as a cooling stream in indirect heat exchange with the sweetened gas stream in heat exchanger 48. The methane refrigerant stream is directed to a dual coupled compressor 412a, 412b via line 414, before being passed to an air cooled heat exchanger 416, and returned via line 402 to the heat exchanger 404.

It will be appreciated that the process of the present invention may be integrated with any light hydrocarbon liquefaction process, independent of the type of refrigeration circuit or number of circuits used.

In addition to the cascaded refrigeration system represented in FIG. 1, other refrigeration circuits for liquefying light hydrocarbon, in particular methane, known to the art can also be integrated with the present invention. The systems described herein merely provide exemplary illustrations of the use of the present invention with other refrigeration systems for liquefying feed gas and should not be considered as limiting the methods of the present invention to the specific refrigeration systems described.

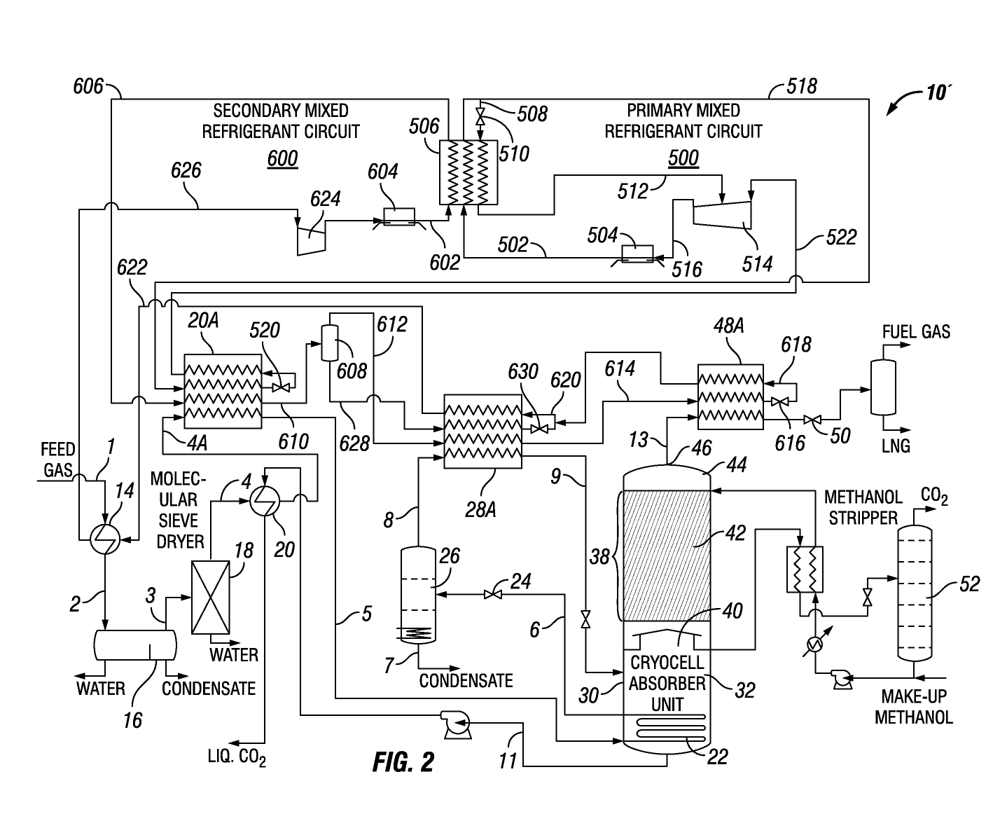

Another example representing a typical arrangement of a dual-mixed refrigeration circuit is described below with reference to FIG. 2. In this particular embodiment, the dual-mixed refrigerant circuit comprises a first mixed refrigerant circuit 500 and a second mixed refrigerant circuit 600. The preferred refrigerant in the first mixed refrigerant circuit 500 comprises about 40%-60% ethane and about 40%-60% propane. The preferred refrigerant in the second mixed refrigerant circuit 600 comprises about 0-10% nitrogen, about 40-50% methane, about 40%-50% ethane, and about 0-10% propane.

The application and operation of the present invention shown in FIG. 2 in this example is essentially similar to the previous example described with reference to FIG. 1 and is briefly described here where like numerals refer to like parts throughout. The differences mainly concern the integration of the first and second mixed refrigerant circuits 500, 600.

A feed gas stream is introduced to the apparatus 10′ via a line 1 to a heat exchanger 14 where the gas stream is cooled to ambient conditions, preferably to a temperature just above the temperature at which hydrocarbon hydrates form (typically around 20° C.). Depending on the composition of the feed gas stream, heavy hydrocarbon condensates may also form in heat exchanger 14. Cooling is effected in the heat exchanger 14 by indirect heat exchange with the second mixed refrigerant from the first second mixed refrigerant circuit 600. The gas stream is passed via a line 2 to a separator 16 and subsequently forwarded via a line 3 to a dehydrating unit 18 where it may be dehydrated as described previously.

Following dehydration, the gas stream is passed from the dehydrating unit 18 via line 4 to a heat exchanger 20 where the gas stream is cooled by indirect heat exchange with a cooled stream of liquid sour species, and subsequently via line 4a to a multi-pass heat exchanger 20a where the gas stream is further cooled by indirect heat exchange with the first mixed refrigerant.

The gas stream is then passed via line 5 to a heat exchange tube bundle 22 in indirect heat exchange with a slurry of sour species solids in liquid sour species where it is further cooled. The gas stream is passed via line 6 to valve 24 where it is flashed to a pressure below the critical pressure of the gas, and passed to a fractionation column 26 in which a condensate of liquid petroleum gas (mainly comprising C3 and C4 hydrocarbons) and heavier hydrocarbons is separated from the gas stream. The resultant condensate is then directed through a line 7 to a condensate stabilizer or other fractionators (not shown) for further treatment to recover other saleable higher hydrocarbon product(s).

The operating conditions of the fractionation column 26 may be as described previously.

The gas stream from the top of the fractionation column 26 is directed through a line 8 to a multi-pass heat exchanger 28a to cool the gas stream to a temperature marginally greater than a temperature at which solidification of the sour species in the gas stream occurs. Generally, the gas stream is cooled to a temperature in a range of about −65° C.-−70° C. In this particular embodiment, cooling in heat exchanger 28a may be obtained from indirect heat exchange with the secondary refrigerant stream.

The cooled gas stream is then fed via line 9 to an inlet 30 of separation vessel 32. The gas stream is expanded using a Joule-Thomson valve or other suitable expansion means such as a turbo expander to further cool the stream as it enters the vessel 32. The gas stream entering the vessel 32 at inlet 30 to about −50 to −90° C. at a typical pressure range of 20 to 30 bar.

Upon cooling the gas stream, as described above, in addition to solid and/or liquid sour species, a small amount of liquid condensate of NGL may also form under the temperature and pressure conditions in the cooling vessel 32. The solid sour species and the liquid condensate migrate to a lower portion of the vessel 32 under gravity separation, thereby forming a slurry of natural gas liquids and solid and/or liquid sour species, as described previously.

The slurry of solid sour species is then heated to a temperature at which the solids melt by indirect heat exchange with tube bundle 22. The liquid stream rich in the sour species is removed from the vessel 32 through conduit 11, and may be further dealt with as described with reference to FIG. 1.

The cooled partially sweetened gas stream with residual sour species may be treated with liquid solvent to deplete it of residual sour species by directing the cooled partially sweetened gas stream to a solvation zone 38 in an upper portion of the cooling vessel 32, as shown in FIG. 2 through a chimney tray 40. As previously described with reference to FIG. 1, cooled liquid solvent, preferably methanol, is introduced into the solvation zone 38 of the vessel 32 through inlet 44 disposed above a liquid-gas intermixing means 42.

The resulting cooled sweetened gas stream is removed from the solvation zone 38 at outlet 46 via line 13, and is directed to a second cooling zone 48a comprising a multi pass heat exchanger where the cooled sweetened gas stream is cooled to a temperature at or below the temperature at which the hydrocarbons in the gas stream condense. Preferably, the cooled sweetened gas stream is cooled to a temperature below the methane boiling point, for example to a temperature between about −140° C. to −150° C. by indirect heat exchange with the second mixed refrigerant.

The liquefied stream may be further expanded in expander 50 and cooled to about −162° C. and atmospheric pressure for storage purposes.

Rich solvent from the solvation zone 38 may be regenerated as described previously with reference to FIG. 1. Similarly, the liquid stream recovered from the fractionator 26 may be further processed as described previously with reference to FIG. 1. The sour vapour stream produced in column 52 can be compressed and liquefied to be combined with the sour liquid stream produced in column 32 to be then disposed (not shown).

Referring to FIG. 2, the configuration and operation of the first mixed refrigerant circuit 500 is described.

First mixed refrigerant stream 502 is withdrawn from the first mixed refrigerant cooler 504 and is directed to a heat exchanger 506 and further cooled. The cooled first mixed refrigerant stream is split. A first portion of the split stream is directed via line 508 to a pressure reduction device 510 and expanded to a lower pressure, thereby lowering its temperature. The cooled first portion of the split stream is passed through heat exchanger 506 in countercurrent indirect heat exchange with the first mixed refrigerant stream and the second mixed refrigerant stream, then directed via line 512 to an inlet of a compressor 514 where it is compressed and returned via line 516 to the first mixed refrigerant cooler 504.

A second portion of the split stream is passed through heat exchanger 20a via line 518, then directed to a pressure reduction device 520 and expanded to lower its temperature. The cooled second portion of the split stream is then redirected through heat exchanger 20a in countercurrent indirect heat exchange with the first mixed refrigerant stream, the second mixed refrigerant stream and the dehydrated gas stream.

The second portion of the split stream is then passed via line 522 to an inlet of the compressor 514 where it is compressed and returned via line 516 to the first mixed refrigerant cooler 504.

Referring to FIG. 2, the configuration and operation of the second mixed refrigerant circuit 600 is now described.

Second mixed refrigerant stream 602 is withdrawn from the second mixed refrigerant cooler 604 and is directed to a heat exchanger 506 and further cooled.

The cooled second mixed refrigerant stream is directed via line 606 to heat exchanger 20a, and subsequently passed to separator 608 via line 610.

The top product from the separator 608 is passed to heat exchanger 28a via line 612 and subsequently to heat exchanger 48a via line 614. The resulting second refrigerant stream is expanded in pressure reduction device 616 and the temperature of said stream is lowered. The expanded stream is re-directed to heat exchanger 48a via line 618 where it is used to cool the sweetened gas from the solvation zone 38 to temperatures at which hydrocarbons condense as described previously. The expanded stream is also used to cool the second refrigerant stream in heat exchanger 48a.

After passing through heat exchanger 48a, the stream is directed to heat exchanger 28a via line 620 where it is used to cool the dehydrated gas stream and the second refrigerant stream.

Subsequent to pass through heat exchanger 28a, the stream is directed to heat exchanger 14 via line 622 where it is used to cool the feed gas stream. The stream is then passed to an inlet of compressor 624 via line 626.

The bottoms product of separator 608 is passed to heat exchanger 28a via line 628. The resulting cooled stream is directed to a pressure reduction device 630 and re-directed to heat exchanger 28a via line 620.

It will be readily appreciated that the various embodiments of the process and apparatus of the present invention may be employed to liquefy gas streams with varying composition. In particular, the components comprising the first cooling zone for cooling the gas stream in a manner to produce a cooled gas stream comprising gaseous hydrocarbons and residual sour species, may vary depending on the composition of the feed gas. For example, for gas streams rich in methane and lean in sour species, such as pipeline specification gas where the concentration of sour species therein can be described as residual, the first cooling zone may comprise one or more cooling means as previously discussed to merely cool the gas stream to the desired temperature. Alternatively, for gas streams rich in carbon dioxide, the first cooling zone may comprise one or more cooling means configured to deplete the gas stream of sour species to residual concentrations, including fractionating columns configured for bulk removal of carbon dioxide for carbon dioxide concentrations greater than about 20-25%. In a further alternative, for gas streams rich in carbon dioxide and NGL components, the first cooling zone may comprise one or more cooling means configured to deplete the gas stream of sour species to residual concentrations and one or more fractionators to deplete the gas stream of C3+ hydrocarbons, and so forth.

As will be evident from the foregoing description, the process and apparatus of the present invention facilitates a reduction of greenhouse gas emissions in comparison with conventional technologies for liquefaction of a gas stream contaminated by sour species.

A financial instrument tradable under a greenhouse gas Emissions Trading Scheme (ETS) may be created by exploitation of the apparatus 10 of the present invention or a gas liquefaction plant employing the processes of the present invention. The instrument may be, for example, one of either a carbon credit, carbon offset or renewable energy certificate. Generally, such instruments are tradable on a market that is arranged to discourage greenhouse gas emission through a cap and trade approach, in which total emissions are ‘capped’, permits are allocated up to the cap, and trading is allowed to let the market find the cheapest way to meet any necessary emission reductions. The Kyoto Protocol and the European Union ETS are both based on this approach. One example of how credits may be generated by using the gas liquefaction plant follows. A person in an industrialised country wishes to get credits from a Clean Development Mechanism (CDM) project, under the European ETS. The person contributes to the establishment of a gas liquefaction plant comprising one or more gas liquefaction apparatuses according to the present invention or a gas liquefaction plant employing the processes of the present invention. Credits (or Certified Emission Reduction Units where each unit is equivalent to the reduction of one metric tonne of CO₂ or its equivalent) may then be issued to the person. The number of CERs issued is based on the monitored difference between the baseline and the actual emissions. It is expected by the applicant that offsets or credits of a similar nature to CERs will be soon available to persons investing in low carbon emission energy generation in industrialised nations, and these could be similarly generated.

Now that embodiments have been described, it will be appreciated that some embodiments have some of the following advantages:
the gas liquefaction processes and apparatus is suitable for treatment of gas streams with high carbon dioxide content, in particular gas streams from gas fields which were previously economically unviable to develop because of the high capital and operation expenditure associated with carbon dioxide separation;
the gas liquefaction apparatus of the present invention occupies a relatively small footprint and thus can be scaled for production of LNG from small to medium scale gas stream sources which were previously economically unviable to develop because production values did not justify capital expenditure, such as for example high CO₂ content small to medium scale stranded gas fields, small to medium scale high CO₂ coal bed methane, biogas, and landfill gas sites.
a “front-end” gas pre-treatment unit to remove carbon dioxide as used in conventional LNG plants is no longer required and thus there will be a significant reduction in capital expenditure estimated to be between 10-30% of the total cost of an LNG process unit;
the redundancy of the “front-end” gas pre-treatment unit simplifies the operation of the liquefaction plant, and removes associated utility requirements such as water treatment and heating systems, thereby reducing fuel usage, energy consumption, and operational and maintenance costs;
carbon dioxide is separated in liquid form suitable for sequestration as opposed to being vented into the atmosphere as with conventional solvent extraction and/or membrane separation techniques;
carbon credits may be generated; and
the gas liquefaction apparatus occupies a relatively small footprint and thus can be scaled for production of LNG for use as vehicle fuel in remote locations, such as for example, remote mine sites.

In the description of the invention, except where the context requires otherwise due to express language or necessary implication, the words “comprise” or variations such as “comprises” or “comprising” are used in an inclusive sense, i.e. to specify the presence of the stated features, but not to preclude the presence or addition of further features in various embodiments of the invention.

It is to be understood that, although prior art use and publications may be referred to herein, such reference does not constitute an admission that any of these form a part of the common general knowledge in the art, in Australia or any other country.

Numerous variations and modifications will suggest themselves to persons skilled in the relevant art, in addition to those already described, without departing from the basic inventive concepts. All such variations and modifications are to be considered within the scope of the present invention, the nature of which is to be determined from the foregoing description.

What is claimed is:

1. A process for liquefying a gas stream comprising hydrocarbons and sour species, the process comprising the steps of:
a) cooling the gas stream by heat exchange with a first refrigerant stream to a temperature marginally greater than at which solidification of the sour species occurs;
b) further cooling the gas stream to a first temperature between about −80° C. to −95° C. at a pressure between about 15 to 25 bar by expanding the gas stream as it is introduced into a vessel to produce a mixture of solid and/or liquid sour species and a cooled gas stream comprising gaseous hydrocarbons and residual sour species;
c) separating the solid and/or liquid sour species from the cooled gas stream in the vessel;
d) contacting the cooled gas stream with a solvent under temperature conditions close to or at the first temperature to deplete the cooled gas stream of residual sour species, thereby producing a cooled sweetened gas stream; and
e) cooling the cooled sweetened gas stream to a second temperature below the methane boiling point by heat exchange with a second refrigerant stream to produce liquid hydrocarbons.

2. The process according to claim 1, wherein the first temperature is at or just below the temperature at which the sour species solidifies and/or condenses.

3. The process according to claim 1, wherein the first temperature is a temperature at which freezable hydrocarbon species condense.

4. The process according to claim 1, wherein the first temperature is a temperature at which solubility of the residual sour species in the solvent used in step d) is optimized.

5. The process according to claim 1, wherein the sour species is more soluble in the solvent than the gaseous hydrocarbons.

6. The process according to claim 1, wherein in at least one of step a) and/or step e), cooling the gas stream comprises a heat exchange step selected from the group consisting of expanding the gas stream in one or more expansion steps, effecting an indirect heat exchange with one or more cooling streams, effecting a direct heat exchange with a cooling stream, one or more heat exchange and/or expansion steps.

7. The process according to claim 1, wherein the solid and/or liquid sour species are separated from the mixture under gravity, centrifugal force, or with other separations means.

8. The process according to claim 1, wherein the process further comprises the step of removing the solid sour species, preferably by heating and melting the solid sour species, thereby forming a liquid rich in sour species.

9. The process according to claim 8, wherein the process further comprises heating the solid sour species to a temperature at or just above the melting point of the solid sour species.

10. The process according to claim 1, wherein prior to performing step a) the gas stream is treated in a fractionation column configured to operate at a temperature of about −35° C. to −45° C. at the inlet to the fractionation column and about −55° C. to −60° C. at the outlet of the top of the fractionation column at operating pressures of around 55-60 barg to produce a liquid stream of carbon dioxide, ethane and C3+ hydrocarbons and a gas stream having a reduced carbon dioxide concentration.

11. The process according to claim 1, wherein prior to performing step a), the gas stream is treated in a fractionation column configured to operate at a temperature of about −15° C. at the inlet to the fractionation column and about −30° C. to −40° C. at the outlet of the top of the fractionation column at operating pressures of around 55-60 barg to produce a C3+ hydrocarbon liquid and a C3+ hydrocarbon-depleted gas stream.

12. A gas liquefaction apparatus for liquefying a gas stream comprising hydrocarbons and sour species, the gas liquefaction apparatus comprising:
a first cooling zone comprising one or more heat exchangers for cooling the gas stream to a temperature marginally greater than that at which the sour species solidifies and a vessel for further cooling the gas stream to a first temperature between about −80° C. to −95° C. at a pressure between about 15 to 25 bar by expanding the gas stream as it is introduced into the vessel to produce a mixture of solid and/or liquid sour species and a cooled gas stream comprising gaseous hydrocarbons and residual sour species, the first cooling zone being in fluid communication with a source of gas comprising hydrocarbons and sour species;
the vessel being configured to separate solids and/or liquids from the cooled gas stream in the mixture;
a solvation zone arranged, in use, to contact the cooled gas stream with a solvent under temperature conditions close to or at the first temperature to deplete the cooled gas stream of residual sour species, thereby producing a cooled sweetened gas stream; and
a second cooling zone in fluid communication with the vessel, the second cooling zone comprising a heat exchanger configured to receive and cool the cooled sweetened gas stream to a second temperature between −140° C. to −150° C. to produce liquid hydrocarbons.

13. A process for recovering liquid carbon dioxide from a gas stream comprising hydrocarbons and carbon dioxide during liquefaction, the process comprising the steps of:
a) cooling the gas stream by heat exchange with a first refrigerant stream to a temperature marginally greater than at which solidification of carbon dioxide;
b) further cooling the gas stream to a first temperature between about −80° C. to −95° C. at a pressure between about 15 to 25 bar by expanding the gas stream as it is introduced into a vessel to produce a mixture of solid and/or liquid carbon dioxide and gaseous hydrocarbons and residual carbon dioxide;
c) separating the solid and/or liquid carbon dioxide from the mixture in the vessel, thereby producing a cooled gas stream comprising gaseous hydrocarbons and residual carbon dioxide;
d) heating the separated solid carbon dioxide and producing liquid carbon dioxide;
e) contacting the cooled gas stream with a solvent under temperature conditions close to or at the first temperature to deplete the cooled gas stream of residual carbon dioxide, thereby producing a cooled sweetened gas stream; and
f) cooling the cooled sweetened gas stream to a second temperature below the methane boiling point by heat exchange with a second refrigerant stream to produce liquefied hydrocarbons.

14. A method of creating a financial instrument tradable under a greenhouse gas Emissions Trading Scheme (ETS), the method comprising the step of exploiting a process for liquefying a gas stream defined by claim 1.

15. A method of creating a financial instrument tradable under a greenhouse gas Emissions Trading Scheme (ETS), the method comprising the step of exploiting a gas liquefaction apparatus defined by claim 12.

16. A method of creating a financial instrument tradable under a greenhouse gas Emissions Trading Scheme (ETS), the method comprising the step of exploiting a process for recovering carbon dioxide from a gas stream comprising hydrocarbons and carbon dioxide during liquefaction defined by claim 13.

17. A method according to claim 14, wherein the financial instrument comprises one of either a carbon credit, carbon offset or renewable energy certificate.

18. The process according to claim 1, wherein the gas stream is cooled in step a) to a temperature in a range of about −65° C. to −70° C.

19. The process according to claim 1, wherein the second temperature is between −140° C. to −150° C.

20. The process according to claim 1, wherein cooling the cooled sweetened gas stream to the second temperature comprises further cooling the cooled sweetened gas stream to about 162° C. at atmospheric pressure.

21. The process according to claim 20, wherein further cooling comprises expanding the cooled sweetened gas stream.

22. The apparatus according to claim 12, wherein the solvation zone is disposed in an upper portion of the cooling vessel.

23. apparatus according to claim 12, wherein the solvation zone is disposed externally of the cooling vessel.

24. The apparatus according to claim 12, further comprising a cascaded refrigeration system comprising a first refrigeration circuit, a second refrigeration circuit and a third refrigeration circuit, wherein the first and second refrigeration circuits provide cooling for the first cooling zone and the third refrigeration circuit provides cooling for the second cooling zone.

25. The apparatus according to claim 12, further comprising a dual-mixed refrigeration circuit comprising a first mixed refrigerant circuit and a second mixed refrigerant circuit, wherein the first mixed refrigerant circuit is configured to cool the second mixed refrigerant circuit and the second mixed refrigerant circuit is configured to provide cooling for the first cooling zone and the second cooling zone.
